(19) United States
(12) Patent Application Publication
(10) Pub. No.: US 2026/0102968 A1
(43) Pub. Date: Apr. 16, 2026

(54) Systems And Methods For Generating Composite Components

(71) Applicant: Jason Heard, Lake Elsinore, CA (US)

(72) Inventor: Jason Heard, Lake Elsinore, CA (US)

(21) Appl. No.: 19/358,040

(22) Filed: Oct. 14, 2025

Related U.S. Application Data
(60) Provisional application No. 63/706,847, filed on Oct. 14, 2024.

(51) Int. Cl. B29C 64/188; B29C 64/30; B29L 31/30; B33Y 80/00

(52) U.S. Cl. CPC B29C 64/188; B29C 64/30; B33Y 80/00; B29L 2031/30

(57) ABSTRACT

This inventive manufacturing process presents a novel approach to creating composite components that eliminates the traditional requirement for molds or plugs by utilizing three-dimensional printing technology. The method significantly simplifies component production and enables the creation of unique parts without the need for separate molds for each component. The process begins with computer-aided design software to design vehicle components such as body panels or dashboards, which are then printed using a 3D printer. Following printing, the component may undergo finishing procedures including sanding, buffing, and application of fillers. The cleaned component is subsequently wrapped with one or more composite sheets, which may include materials such as fiberglass, carbon fiber, or Kevlar, using resin to ensure proper adhesion and saturation. The final manufacturing steps involve placing the component in a sealed bag, applying vacuum pressure to remove air, and allowing the resin to cure.

This application claims priority to U.S. provisional application having Ser. No. 63/706,847 filed on Oct. 14, 2024. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is composite structures.

### BACKGROUND

The following description includes information that may be useful in understanding the present invention. It is not an admission that any of the information provided herein is prior art or relevant to the presently claimed invention, or that any publication specifically or implicitly referenced is prior art.

Traditionally, components for vehicles typically utilize a mold or plug to create the component. As an example, using a mold, a component could be created through an injection molding process. Plastic compression molding can also be used for larger, thicker, or simpler components.

Both processes suffer from the same disadvantage, in that they require a mold or plug to form the component, which limits the ability to create one-off or more unique components due to the higher cost and time involved to create the mold or plus.

All publications identified herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

Thus, there is still a need for improved processes for generating composite components that eliminate the need for a mold or plug.

### SUMMARY OF THE INVENTION

The inventive subject matter provides apparatus, systems, and methods for generating composite components or structures, especially those used in automotive and other vehicles.

An exemplary process utilizes a 3D printer to print the base of the component. Exemplary components could comprise, for example, a body panel or a dashboard, although virtually any component could be generated. The printed component is then cleaned up as needed (e.g., sanded, buffed, etc. Once this is completed, the finished component is then wrapped with a composite sheet, such as fiberglass, carbon fiber, Kevlar™, and so forth. A resin can be used to help the wrap stick to the printed component and additional resin may be applied to saturate the wrap material, for example. It is contemplated that the wrap may comprise multiple layers of one or more materials to achieve a desired thickness and strength. The component may then be sealed in a vacuum bag with a vacuum removing the air in the bag. Once a vacuum has been achieved, the resin can be allowed to cure, which may occur at room temperature or in an oven, for example. This ensures the carbon fiber conforms tightly to the shape, removing air pockets and excess resin to create a strong, dense, and void-free component.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

FIGS. 1A-1B illustrates an exemplary three-dimensional printer printing a component.

FIG. 2 illustrates various steps of an exemplary method for generating a composite component.

### DETAILED DESCRIPTION

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

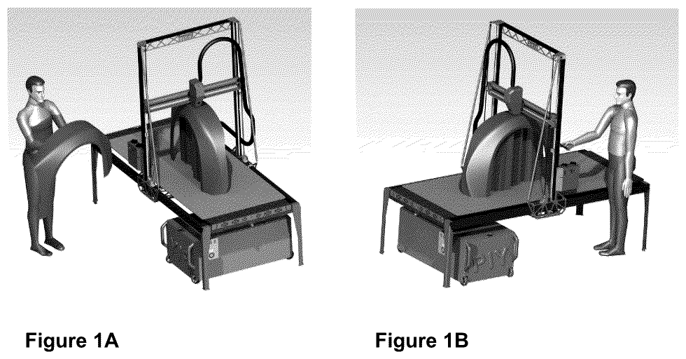

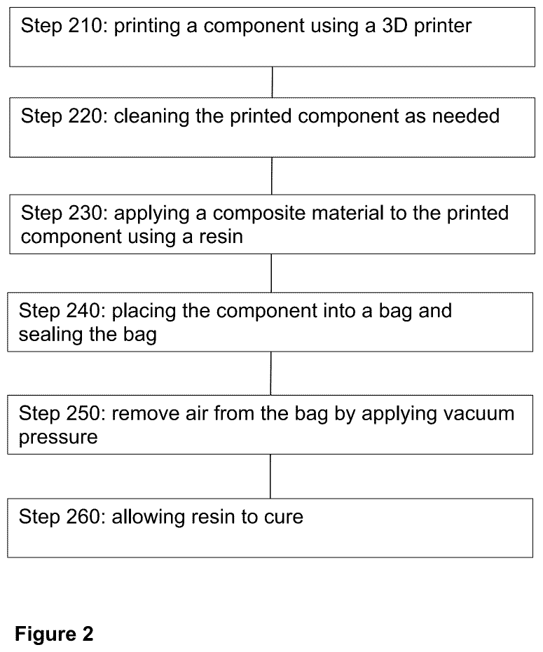

As discussed briefly above, the inventive subject matter is directed to the creation of composite components without the need for a mold or plug. Instead, the components can be printed using a three-dimensional printer or other means, such as shown in FIGS. 1A-1B. This greatly simplifies the process and allows for unique components to be printed without having to create a separate mold for each part. The process is simple and exemplary steps are shown in FIG. 2. A part that will actually be placed on the vehicle (such as a body panel or dashboard, for example) is designed in CAD software and can then be printed using a 3D printer in step 210. The printed component can then be cleaned up or finished as needed in step 220. Such steps could include, for example, sanding the component, buffing the component, and/or applying a filler such as Bondo™.

The cleaned component can then be wrapped with a composite sheet in step 230, which may include, but is not limited to, fiberglass, carbon, Kevlar, and so forth. Resin can be used to apply the composite sheet to the component. For example, it is contemplated that resin can be applied to the component to help the composite sheet stick to the component. Additional resin may be applied to the component to ensure it is wet and saturated. It is further contemplated that this process can be repeated to allow for multiple composite sheets to be applied which may be the same or a different material.

Once completed, the component is placed into a bag and sealed in step 240. A vacuum can then be used to remove air from the bag in step 250. Once this is done, the resin can be allowed to cure in step 260. This may be done, for example, by using room temperature or by using a heat source such as an oven to accelerate the curing process.

Once the resin has cured, the finished component can be removed from the bag.

Thus, using the inventive subject matter described herein, the printed part is used as a core of the composite component. Essentially, the core may be a plastic center that is wrapped in composite and then utilized directly on the automobile, boat, aircraft, or other vehicle. The inventive subject matter solves the primary problem with traditional part creation by eliminating the need for a mold or plug to make the component/body for a vehicle. Advantageously, the inventive subject matter allows for the creation of “one off” components that are not beholden to a mold/plug like traditional composite components.

The inventive subject matter also allows for the design of the components to be more organic/unique because the component is not beholden to a mold/plug and must be designed to be able to be removed from the mold/plug. This unleashes the creativity and ability for designers to venture into new realms of shape and form with composite construction in vehicles.

By eliminating the traditional steps needed to make a mold/plug, the process reduces the overall time and cost to create the component. This allows for the “one off” ability to go from design/concept to a final product more quickly. It also allows for the ability to “tweak/change” the design and reprint a revised component immediately without having to scrap molds/plugs from the previous version of the component.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

Unless the context dictates the contrary, all ranges set forth herein should be interpreted as being inclusive of their endpoints and open-ended ranges should be interpreted to include only commercially practical values. Similarly, all lists of values should be considered as inclusive of intermediate values unless the context indicates the contrary.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for generating a composite component for a vehicle, comprising:
instructing a component for a vehicle to be printed using a three-dimensional printer; and
wrapping the printed component in a composite to generate a composite component.

2. The method of claim 1, wherein the composite comprises a composite sheet.

3. The method of claim 2, wherein the composite sheet comprises a carbon fiber material or a fiberglass material.

4. A method for generating a composite component for a vehicle, comprising:
printing a component for a vehicle using a three-dimensional printer;
apply a resin to the printed component and affixing a composite material to the printed component;
placing the printed component with the composite material into a container;
sealing the container and removing air from the container to create a vacuum; and
curing the resin to create a composite component comprising the printed component and the composite material.

5. The method of claim 4, wherein the printed component is formed of a plastic.

6. The method of claim 4, wherein the step of affixing a composite material to the printed component further comprises affixing two or more layers of a composite material to the printed component.

7. The method of claim 4, wherein the composite material comprises a sheet of material.

8. The method of claim 7, wherein the composite material comprises a carbon fiber material or a fiberglass material.
